(19) United States
(12) Patent Application Publication
(10) Pub. No.: US 2015/0169937 A1
(43) Pub. Date: Jun. 18, 2015

(54) USE OF SPECTRAL UNMIXING TO CLARIFY MORPHOLOGY

(71) Applicant: Gooch & Housego PLC, Ilminster (GB)

(72) Inventors: Elliot S. Wachman, Lakewood, NJ (US); Joel M. Recht, Monsey, NY (US); Stanley J. Geyer, Pittsburgh, PA (US)

(21) Appl. No.: 14/104,565

(22) Filed: Dec. 12, 2013

(51) Int. Cl. G06K 9/00

(52) U.S. Cl. CPC G06K 9/00127

(57) ABSTRACT

A method of presenting image data for elucidating morphology. The method includes the steps of: obtaining a spectral image data set of a sample, wherein the sample is labeled with a plurality of transmission stains; calculating a plurality of rule images from the spectral image data set; adjusting a level of intensity of one of the plurality of rule images independent of the other of the plurality of rule images; and presenting the plurality of rule images to a user.

### BACKGROUND

The present invention relates to spectral unmixing and the elucidation of morphology in samples such as multiply-stained clinical samples where heavily overlapping stains can obscure identification of disease.

A spectral image “cube” consists of a set of images each acquired at a different wavelength. Spectral image sets can be acquired of samples that are reflective, transmissive, or fluorescent. In many cases of interest, the final acquired image arises from the combined effect of various often co-localized, spectrally-varying components present in the sample or scene being imaged, each with its own “reference spectrum”. Using various analysis techniques known to those skilled in the art, the final image may be decomposed into separate “rule images”, one for each reference spectrum, with the pixel-by-pixel intensity of each rule image corresponding to the calculated relative amount of that spectral component calculated to be present in the acquired image.

### SUMMARY

This Summary is provided to comply with 37 C.F.R. §1.73, presenting a summary of the invention to briefly indicate the nature and substance of the invention. It is submitted with the understanding that it will not be used to interpret or limit the scope or meaning of the claims.

Clinical and biological samples are typically labeled with various known stains specific to the molecular, chemical or structural moieties of interest. One of the more useful applications of spectral unmixing to these types of samples involves the labeling of various types of biomarkers, each with its own distinctive stain, in addition to one or more stains used to delineate cellular morphology or tissue architecture.

Visualizing the results of spectral unmixing on a given multi-stained clinical sample can be done in a number of ways. Each rule image can be presented separately, either in grayscale or in false color, so that the relative abundance of each stain in the sample can be seen clearly. Alternatively, the rule images can be independently false colored and then overlaid on one another in order to reveal the spatial relationships and co-localizations of the various stains present. These types of visualization techniques are often used in situations where the stains in question indicate the presence of various biomarkers of clinical relevance to the sample in question.

The inventors have recognized an additional type of visualization technique which may be applied to cases where multiple component morphology stains are used, such as the Pap stain or Masson's trichrome stain. It is a common occurrence to find darkly stained cells or clumps of cells whose morphology is difficult to interpret as a result of the darkness of the staining Ordinarily, a pathologist will endeavor to examine the morphology of such cells by adjusting the illumination intensity of his microscope, the condenser positioning or the objective focusing. These techniques can frequently give important additional perspectives as to cell morphology. Ideally, however, the pathologist would really like to lighten, or even remove entirely, one or more of the component stains that are obscuring direct view of the cellular features of interest.

Accordingly, disclosed herein are methods and systems for using a spectral unmixing visualization technique to elucidate morphology in transmission stain samples by a) producing rule images for each of the component stains used; b) recolorizing each such rule image appropriately; c) combining said recolorized images to form the complete recolorized image; d) providing means to independently vary the relative intensities of each of the recolorized images in the combination image to best elucidate the morphological features of interest.

In one embodiment, the invention provides a method for elucidating morphology in a Pap-stained biological cytology or histology sample. A spectral image cube is acquired of the sample, and spectral unmixing is performed to produce rule images for each of the four components of the Pap stain. In many cases, linear spectral unmixing may be used, in which the acquired spectrum at each pixel may be expressed as a linear combination of the contribution from each of the various reference spectra. These rule images may then be recolorized and combined to form color Pap images which can correspond to the pathologist's personal colorization preference, even if this does not correspond to the actual colors seen under the microscope. Using slider controls for each of the Pap components, the pathologist can vary the displayed intensity of these four components in real-time, until a suitably enhanced image is obtained, enabling unambiguous evaluation of the morphology of the Pap-stained cell or cells in question.

Accordingly, in one embodiment, the invention provides a method of presenting image data for elucidating morphology. The method includes the steps of: obtaining a spectral image data set of a sample, wherein the sample is labeled with a plurality of transmission stains; calculating a plurality of rule images from the spectral image data set; adjusting a level of intensity of one of the plurality of rule images independent of the other of the plurality of rule images; and presenting the plurality of rule images to a user.

In another embodiment the invention provides a system for presenting image data for elucidating morphology. The system includes an image display system and a controller operatively connected to the image display system, where the controller has a microprocessor coupled to a memory. The controller is configured to obtain a spectral image data set of a sample, wherein the sample is labeled with a plurality of transmission stains, calculate a plurality of rule images from the spectral image data set, adjust a level of intensity of one of the plurality of rule images independent of the other of the plurality of rule images, and present the plurality of rule images to a user using the image display system.

Other aspects of the invention will become apparent by consideration of the detailed description and accompanying drawings.

### BRIEF DESCRIPTION OF THE DRAWINGS

FIG. 1 is a flow chart describing the various steps required for an embodiment of the invention.

FIG. 2 illustrates a Pap-stained cervical cell sample before (a) and after (b) adjustment of the various Pap stain component relative intensities. The user interface to control the stain component intensities is shown below each image.

FIGS. 3a-3d show an example of two Pap-stained cell clumps before ((a) and (c)) and after ((b) and (d)) removal of all but the Hematoxylin Pap stain component.

FIGS. 4a-4b illustrate a Pap-stained cervical tissue sample before (a) and after (b) adjustment of the various stain component relative intensities.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events.

Furthermore, not all illustrated acts or events are required to implement a methodology in accordance with the present invention.

Embodiments of the invention relate to spectral unmixing and the visualization of morphology in multiply-stained clinical samples where structural features and overlapping stains and can make interpretation of morphology quite difficult.

A pathologist examining a cytology sample must be able to differentiate the nucleus and cytoplasm of the cells he is examining in order to properly identify the type of cell and make an assessment of the risk of disease this cell represents. In histology samples, the pathologist additionally needs to examine tissue architecture in order to make this assessment.

In cytology samples, it is common to find clumps of overlapping cells as well as folding of individual cells. Even in liquid-based cervical cell samples designed to produce near monolayer distributions of the cells across the slide (e.g., ThinPrep from Hologic and SurePath from BD), such clumping and folding is routine. This can often obscure detection of the location and shape of the cell nuclei, thereby complicating an interpretation of the cellular morphology. In histology samples, folding of tissue slices as they are transferred to the slide occurs frequently; additionally, poor fixation can lead to staining artifact. These effects can obscure detection of both cellular morphology and tissue architecture and lead to similar difficulties for the pathologist.

When using multiple component morphology stains such as the Pap stain, the situation can be further complicated. Pap stain consists of four separate component stains, each of which has its own distinctive staining profile. Hematoxylin, a blue-purple stain, attaches to chromatin and primarily stains cell nuclei. Eosin, a pink stain, stains nucleoli, cilia, and cytoplasms of mature squamous cells. Fast Green, a blue stain, stains parabasal squamous cells, intermediate squamous cells, and columnar cells. 0G6, an orange stain, attaches to keratinized cells. The presence of all these stains is required for the pathologist to understand properly the type and morphology of the cells he is examining In many instances, these stains are colocalized and, in combination, can lead to very darkly stained cellular regions that greatly hinder clear visualization of the area in question. This effect is most often a problem in regions of cell folding and clumping and in regions of tissue folding or poor fixation artifact, where staining intensity of the component stains present at said locations is magnified due to the aforementioned anomalies.

A pathologist viewing such regions under a conventional light microscope will endeavor to adjust his illumination source, the microscope condenser position or the sample focus in order to be able to get a clearer view of the regions in question. This approach can be quite time consuming, but is many times successful, although there typically remain a good number of cells that need to be skipped over because they remain uninterpretable (so-called “skipocytes”).

The inventors have recognized an alternative approach to this problem in which spectral imaging, spectral unmixing analysis, and false colorization of the resultant rule images can be used to generate a recolorized image of the sample, closely matching in appearance that of the original sample but with the added advantage that the intensity of some stain components may be adjusted relative to other components. Since each rule image represents the pixel-by-pixel abundance of its respective component stain, the contribution of each component stain to the final image can be adjusted independently, using a software tool.

In a situation, for example, where the pathologist is having difficulty visualizing the Hematoxylin-stained nucleus in a clump of Pap-stained cells due to the high abundance of the other Pap component stains, he can immediately reduce the intensities of these other components using said software tool until he has a sufficiently unobstructed view of the cells in question to make the needed interpretation.

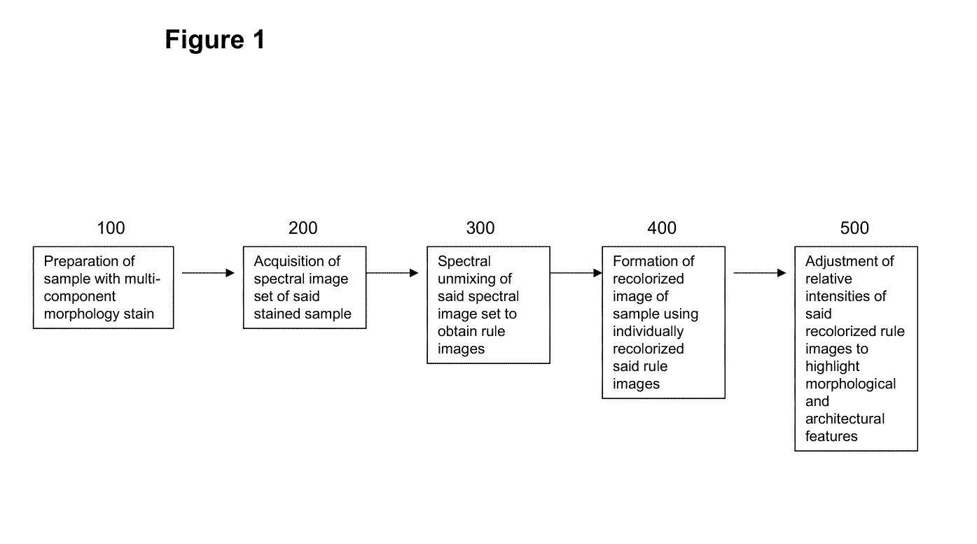

The general methodology of this invention is shown in FIG. 1. In step 100, the sample is stained with the desired multi-component morphology stain, such as Pap stain or Masson's trichrome.

A sample can include any imaged object, whether biological or not. Biological samples can include a solution with single cells or groups of cells as well as tissues. The sample may be single cells and/or groups of cells that are spread onto a substrate such as a coverslip or microscope slide or may also include tissues, including sectioned tissues, that are mounted onto a substrate such as a coverslip or microscope slide.

In step 200, a spectral image set is acquired of the sample prepared in step 100. The sample may be illuminated with UV, visible, and/or infrared light as appropriate and images of the sample may be collected at varying wavelengths or bands of wavelengths. Illuminating and/or collecting images of the sample at varying wavelengths may be performed using bandpass filters, e.g. on a slider or filter wheel; using an acousto-optical tunable filter (AOTF) device; a liquid crystal tunable filter (LCTF); Sagnac-interferometer Fourier systems; tomographic imagers; “push-broom” imaging devices of all types; a collection of interference filters (including those placed as a thin-film mask placed over an imaging device (e.g. a CCD chip) such as in a Bayer pattern or in other types of masking. In various embodiments a spectral image may include a set of images obtained at wavelengths across the visible spectrum, e.g. from 460 to 730 nm at 10 nm intervals.

Methods for preparing samples, collecting images, and processing image data can be found in U.S. application Ser. No. 12/675,677, and U.S. Pat. No. 7,316,904, each of which is incorporated herein by reference in its entirety.

In step 300, spectral unmixing of the image set acquired in step 200 is performed using methods known to those skilled in the art. Rule images are obtained for each stain component used, wherein the value at any pixel of a given rule image indicates the relative amount of that stain component at said pixel.

In step 400, a recolorized image of the sample is created by separately false-coloring the rule image corresponding to each component stain in the sample with a color approximating that of the actual stain component as it would appear on its own, or any other color which helps visualization, and combining said false-colored rule images from all of the components present to form the final recolorized sample image.

In step 500, a software tool is provided which enables the independent adjustment of the intensity of each individual stain component. This may be accomplished using radio buttons, slider bars, arrows, text entries or any similar means. In some embodiments the independent adjustment is performed using a linear increase or decrease of the intensity of a particular stain component, e.g. by adjusting the contrast stretching, although other types of adjustments are also possible. In other embodiments a particular stain component may be displayed completely separate from the other components or with only a small amount of the other components being shown. In various embodiments the intensity of a particular stain component may be held relatively fixed while the intensity of the remaining components is reduced.

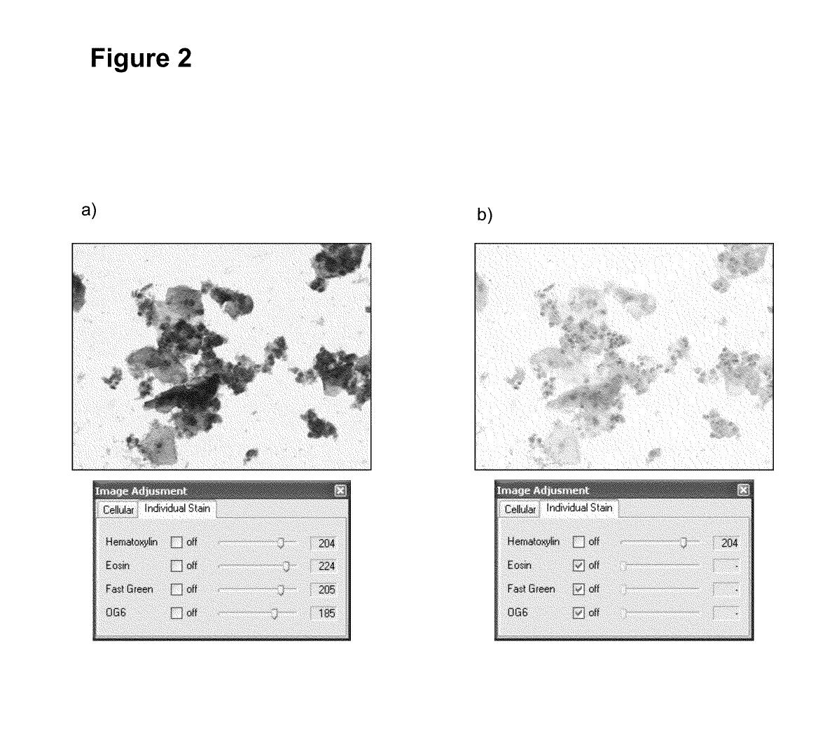

An example of this technique applied to cytology samples is shown in FIG. 2. FIG. 2a shows a clump of cervical cells stained with Pap stain in which it is difficult to differentiate the locations of the nuclei. FIG. 2b shows the same clump of cells with the relative stain intensities adjusted to highlight the nuclei. A slider control panel to control the individual stain intensities is shown below each image. Note the difference in stain intensities between FIGS. 2a and 2b shown in the text boxes at the far right of these panels.

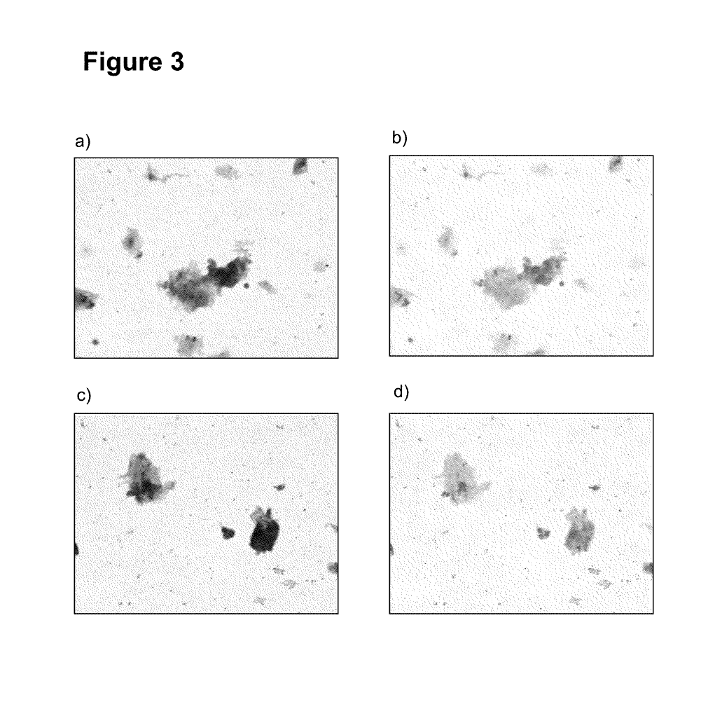

The potential utility of this approach is shown in FIG. 3. FIGS. 3a and 3c are images of Pap-stained cervical cells, each image containing a clump of overlapping cells in which it is difficult to distinguish the individual nuclei of the cells in the clump. FIGS. 3b and 3d show these same images with all but the main nuclear stain, Hematoxylin, removed from the images according to the practices described in this invention. In FIG. 3b, it may be seen that there are several large nuclei that could be potentially abnormal, whereas there are no such nuclei evident in FIG. 3d. Using more conventional visualization techniques as described above, it is likely that both these clumps would be skipped over and, therefore, that the abnormal cells in the clump of FIG. 3a would be missed.

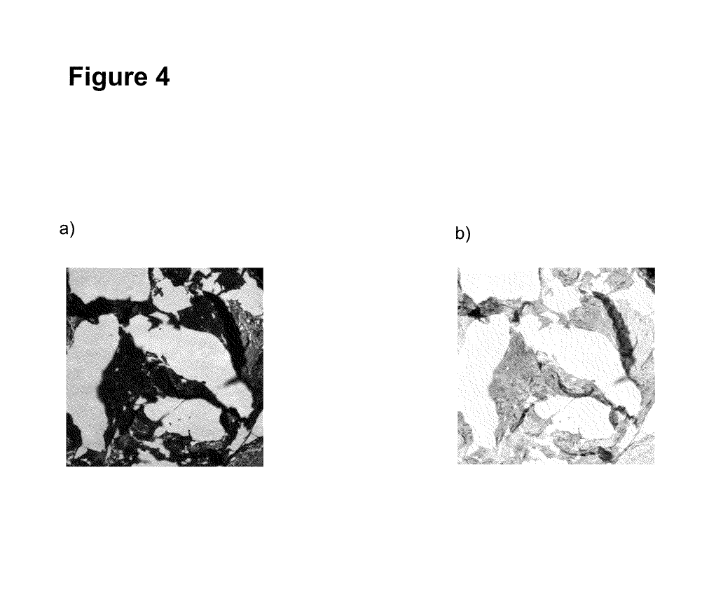

A further example of this technique applied to histology samples is shown in FIG. 4. In FIG. 4a, an image of a cervical tissue sample stained with Pap stain is shown, including several areas where strips of tissues were inadvertently folded over other pieces of tissue during slide preparation. As a result, these regions became stained very darkly, making it difficult to see the tissue architecture in these regions. In FIG. 4b, the same image is shown with all but the Hematoxylin stain removed. In this image architectural features are more clearly evident.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Various features and advantages of the invention are set forth in the following claims.

What is claimed is:

1. A method of presenting image data for elucidating morphology, comprising the steps of:
obtaining a spectral image data set of a sample, wherein the sample is labeled with a plurality of transmission stains;
calculating a plurality of rule images from the spectral image data set;
adjusting a level of intensity of one of the plurality of rule images independent of the other of the plurality of rule images; and
presenting the plurality of rule images to a user.

2. The method of claim 1, wherein presenting the plurality of images to a user comprises applying a false color to each of the plurality of rule images.

3. The method of claim 2, wherein the false color of each of the plurality of rule images approximates a color of a stain component to which each rule image corresponds.

4. The method of claim 1, wherein presenting the plurality of images to a user comprises combining the plurality of rule images.

5. The method of claim 1, wherein calculating a plurality of rule images comprises calculating a plurality of rule images using linear spectral unmixing.

6. The method of claim 1, wherein the plurality of transmission stains have a plurality of reference spectra associated therewith such that each transmission stain has a respective reference spectrum.

7. The method of claim 6, wherein each of the plurality of rule images comprises an array of proportional values representing proportions of the spectral image set that correspond to each of the reference spectra.

8. The method of claim 1, wherein presenting the plurality of rule images to a user comprises real-time presentation on a display device.

9. The method of claim 1, wherein adjusting a level of intensity of one of the plurality of rule images independent of the other of the plurality of rule images includes increasing a level of intensity of one of the plurality of rule images and decreasing an intensity of one of the plurality of rule images.

10. The method of claim 9, wherein decreasing an intensity of one of the plurality of rule images comprises decreasing the intensity to zero.

11. A system for presenting image data for elucidating morphology, comprising:
an image display system; and
a controller operatively connected to the image display system, the controller having a microprocessor coupled to a memory, the controller configured to
obtain a spectral image data set of a sample, wherein the sample is labeled with a plurality of transmission stains,
calculate a plurality of rule images from the spectral image data set,
adjust a level of intensity of one of the plurality of rule images independent of the other of the plurality of rule images, and
present the plurality of rule images to a user using the image display system.

12. The system of claim 11, wherein, to present the plurality of images to a user, the controller is further configured to apply a false color to each of the plurality of rule images.

13. The system of claim 12, wherein the false color of each of the plurality of rule images approximates a color of a stain component to which each rule image corresponds.

14. The system of claim 11, wherein, to present the plurality of images to a user using the image display system, the controller is further configured to combine the plurality of rule images.

15. The system of claim 11, wherein, to calculate a plurality of rule images, the controller is further configured to calculate a plurality of rule images using linear spectral unmixing.

16. The system of claim 15, wherein the plurality of transmission stains have a plurality of reference spectra associated therewith such that each transmission stain has a respective reference spectrum.

17. The system of claim 16, wherein each of the plurality of rule images comprises an array of proportional values representing proportions of the spectral image set that correspond to each of the reference spectra.

18. The system of claim 11, wherein, to present the plurality of rule images to a user using the display system, the controller is further configured to present the plurality of rule images to a user using the display system in real time.

19. The system of claim 11, further comprising an image acquisition system in operative communication with the controller.

20. The system of claim 11, wherein, to adjust a level of intensity of one of the plurality of rule images independent of the other of the plurality of rule images, the controller is further configured to increase a level of intensity of one of the plurality of rule images or decrease an intensity of one of the plurality of rule images.

21. The system of claim 11, wherein, to decrease an intensity of one of the plurality of rule images, the controller is further configured to decrease the intensity to zero.
